(19) United States
(12) Patent Application Publication
(10) Pub. No.: US 2006/0294493 A1
(43) Pub. Date: Dec. 28, 2006

(54) Non blocking persistent state machines on enterprise java bean platform

(76) Inventor: Geir Melby, Heggedal (NO)

Correspondence Address: ERICSSON INC., 6300 LEGACY DRIVE, M/S EVR C11, PLANO, TX, 75024, US

(21) Appl. No.: 10/556,330

(22) PCT Filed: May 12, 2004
(86) PCT No.: PCT/NO04/00143

§ 371 Date: Nov. 10, 2005

(30) Foreign Application Priority Data
May 27, 2003 (NO) 2003419

(51) Int. Cl. G06F 9/44

(52) U.S. Cl. 717/104; 717/114

(57) ABSTRACT

The present invention discloses a method and an arrangement for using a platform independent model comprising one or more state machines, and a generic middleware platform for orthogonally mapping the platform independent model to a source code and/or byte code platform, where an asynchronic behaviour is shown on the modelling level, and the source code or byte code level is achieved using message oriented middleware application API adapted for message exchange between clients both in point to point and publish/subscribe messaging regime and, persistency for one or more state machines is achieved using one or more modules adapted for database transactions, where the modules may handle concurrent access from multiple clients to the database.

### FIELD OF THE INVENTION

The present invention relates to mapping of models with a high level of abstraction to models/applications that can be implemented, through middleware, the present invention particularly comprises a model description with a high level of abstraction that with the use of the present invention can be mapped to a J2EE (Java 2 Enterprise Edition) platform [1].

### BACKGROUND OF THE INVENTION

The combination of mobility and Internet creates a new and powerful industry that will deliver attractive, content-rich services to users on the move. All over the world, companies are preparing for the Mobile Internet. Mobile data networks (e.g. UMTS, WLAN and Bluetooth) with increasing bandwidth, advanced phones and handheld computers are available, bringing a new generation of services into use. For instance, the introduction of I-mode in Japan has been a tremendous success, with millions of subscribers and thousands of service providers that have created market demand for services available through mobile phones.

The expectation of strong growth in the mobile area is one reason for the establishment of the Open Mobile Alliance (OMA), which on their home page stated “The mobile industry has experienced a period of very exceptional growth during the past ten years. The next wave of growth is expected to come from mobile services”.

Until now telecom operators have dominated as service providers for the telecom market. However, deregulation of the telecom sector and requirements from application providers have gradually opened the telecom networks for 3rd parties. 3GPP has specified a set of API's, called Open Service Access (OSA), which gives 3rd party application providers access to the resources and services of the telecom networks. OSA enables telecom services to be integrated with existing Internet applications. This integration has formed an industry, called Information and Communication Technology (ICT), which includes network operators, service providers, equipment vendors, application developers and content providers.

Telecom operators as part of the ICT industry have specified and partly developed the next generation network as shown in FIG. 1. The network architecture logically consists of an access, a control and a service layer. These layers are connected to each other through a high capacity backbone network that is based on the IP protocol.

The access layer consists of different types of access systems, such as mobile networks (GSM, UMTS), wireless networks (WLAN) and ADSL that are connected to the same backbone network. Terminals like phones, PCs and faxes are connected to the different access networks. The control layer consists of different servers as controllers and databases for network resources. These servers provide telecom services, such as basic call set up and traffic control.

The service layer consists of the resources needed to perform additional control and the service logic, which provides value added services to the end user. Service Capability Servers (SCS) provide access to services in the control layer, such as basic call setup. Other components are user and service databases (e.g. HLR—Home Location Register, AAA—Authentication, Authorization and Accounting), Internet portals and application content servers. These components also communicate with resources in the controller layer through the IP backbone network. This layer constitutes the service network and will normally be connected to the Internet.

The Application Server (AS) contains the applications that provide services for end users, or clients. Application servers normally consist of tools for creation, deployment and management of services. Web-logic and JAMBALA are examples of application servers, and they also support software standards as Web services and J2EE (Java 2 Enterprise Edition, an application platform for Enterprise Java Beans) [2].

Application Servers may also provide service access to the Internet through open Internet APIs, such as Web-services. Application servers may also have open access to Internet, enabling applications for access and utilization of other services on the Internet. In this way the service network can be integrated with Internet services.

The migration between the mobile services and among others the web services which will give clients and end users content rich services, indicates the need for advanced, yet tailored development tools for the software designers. In its nature there are inherited differences between the telecom society and the data community, with respect to the design of software applications.

Generally speaking, one might interpret that a picture is more widely understood than words, in analogy design of a software application, using models will be more intuitive, more universal, it will be platform independent and have a simpler semantic and syntactic than a programming language of textual character. Hence there is a wish to design software applications, using a modelling language, and to have compilers that handle the transformation/mapping from a level of modelling and down to a byte code level.

Hence from the sections above it should be evident that there is a need for tools that can orthogonally map between different levels of abstraction, so as to ease implementation of applications for users on the move.

The present invention relates to problems with consistency between low level software, that is the implemented source code/byte code and upward to the abstract model, which is preferably a PIM (Platform independent models). It is important to maintain an independency between the layers/levels, implicitly that is an asynchronicity, further it is important, particularly within telecom where one operates with “actions”, i.e. traditional state machines, to be able to communicate distributed and asynchronous, as well as with persistency. With tools known from the prior art this is impossible. That is; there are no known compilers which can handle highly abstract model descriptions and compile them to implemented software. This is, among other reasons, due to the fact that one does not have model concepts that have a natural or orthogonal mapping to lower platforms, in the meaning of platforms with low level of abstraction. It is an object of the present invention to act as a link or connection between high level models and the bottom platform, which is a link between a highly abstract model description to a concrete description, and still keep an asynchronous, non blocking and persistent solution. This implies that a middleware layer/level is needed with the features of being non blocking and persistent.

Within the community of application designers who develops content added services/applications for the mobile community, J2EE technologies have become a widespread tool, and within the Java community the J2EE technologies are the de facto standard used for development and execution of enterprise applications in the Java community. Today J2EE provides a rather complete set of technologies for development of server side applications. This includes enterprise java beans (EJB) for development of distributable components, Java Naming Directory Interface (JNDI) for lookup of references to components, Remote Methods Invocation (RMI) for transparent communication between distributed objects or components, Java Transaction API (JTA) for transactional support, including roll-back and persistent storage and XML based technologies. The latest J2EE standard also includes a Java Messaging Service (JMS) for support of asynchronous communications and support for applying web-services technologies. Together with support for integration of client technologies as Java Server Pages (JSP) and Servlets, J2EE can be used for implementation of software applications that are distributed, scalable, transactional and persistent. However, J2EE is originally a typical client server technology. Clients make request for information, and servers respond with the requested information.

Entity Bean

Normally entity beans represent persistent data of an application. The enterprise bean interface has methods for accessing the data. An entity bean is identified with a unique primary key, and the home interface must have a method used for finding an entity bean based on the primary key. The data are normally stored in an underlying database, and J2EE recommends that JDBC is used. Entity beans are often associated with database transactions and may handle concurrent access from multiple clients.

Entity beans are transactional, and there are two different types of beans which reflect how the beans handle the persistency of data. In container-managed persistence (CMP) the container guarantees persistency of data, while in bean-managed persistency (BMP) the bean is responsible for storing and restoring the data.

Message Bean

Message-driven beans, or in short, message beans, are asynchronous message consumers. The latest specification has extended the message beans to be able to receive messages from other sources in addition to JMS. A message bean is defined for a single message type, in accordance with the message listener interface it implements. This extension is motivated by the popularity of web services, and it has opened the J2EE architecture to include communication with web services.

Message beans are listening on specific JMS destination or web service endpoints. A JMS destination is either a message queue or a topic. A web service endpoint represents a service interface for a client who calls a web service. When a message is put into a JMS destination, or a client calls a web service endpoint, the container invokes the actual message bean. Which web service endpoints or JMS destinations the message bean shall receive messages from are specified at the deployment time.

Message beans are anonymous and can therefore only be accessed via messages. The container may create several instances of a message bean type, which enables concurrent handling of messages. The container does not guarantee that messages are consumed by the message beans in the same order as they arrive into the destination or endpoint.

Message bean instances are like stateless session beans in the sense that they have no conversional state. When more than one message bean instance are deployed, they must serve all received messages in an equal way.

Java Messaging System

The Java Message Service (JMS) is a Java API that supports MOM functionality. It is a common specification that enables JMS clients to communicate with other messaging implementations, and which provides interoperability between the different MOM products.

The JMS API supports an asynchronous and reliable communication between loosely coupled JMS clients. JMS supports both point-to-point messaging and publish/subscribe messaging. The main differences between these concepts are:
In point-to-point messaging there is only one receiver of each message, while in publish/subscribe messaging; the same message is received by all receivers that have subscribed to the topic.
In point-to-point messaging a message is stored in a queue until it is delivered to a receiver, while in subscribe/publish the message sent to a topic is immediately sent to all subscribers of the topic. There is no queuing of the messages.
Although in messaging there is timing dependency between sending and receiving of messaging, JMS supports two different modes of message reception.
Synchronously, in the sense that the receiver explicitly fetches the message from the queue or topic by calling a receive method. It may be blocked until a message is received, or it may time out.
Asynchronously, in the sense that a receiver may register a listener interface. A message is received when the JMS calls the listener's on Message method at the time the message arrives at the queue, or topic.

A message consists of a header, properties and a body. Properties may carry user specified properties. A receiver can use these properties to filter the messages it receives. JMS support different types of messages, which differ in the format of the message body.

Integration of JMS into J2EE

The JMS API integrated with J2EE has the following features:
Application clients, Enterprise bean components, and Web components can send or synchronously receive a JMS message. Application clients can in addition receive JMS messages asynchronously.
Message-driven beans use asynchronous consumption of messages.
Includes messaging within distributed transactions.
Concurrent consumption of messages by allowing multiple message bean instances.
   Java Naming and Directory Interface

The Java Naming and Directory Interface (JNDI provides an interface for accessing name and directory services, such as LDAP directory services and Domain Name Service (DNS). JNDI enables Java programs to use name servers and directory servers to look up Java objects by name. This feature enables an application to locate distributed objects, which is essential in distributed programming. JNDI is a generic API that works with any name or directory server, and as such it provides a common interface against existing directory and naming servers.

A directory service typically provides access to data structured in hierarchies, such as directories in a file system. It is also used to categorize data into hierarchies, such as “Yellow Pages”. A naming service allows access to objects by name, for instance looking up an IP-address to a computer based on a name as in DNS. In the thesis work the naming service is the most interesting.

Problem Definition

Services provided by applications that are available through the Internet are mainly based on single initiatives from clients. A service is requested by a user via a client to a server, which responses to the request by accessing databases and sending information back to the client. The client server technology as provided by J2EE and http servers is typically used for implementing such services. The tremendous success of the Internet is a proof that this request and response approach works.

Future services will be built on an integration of services provided by various, remote computers. These will lead to loosely coupled computers, physically spread around the world, with variable and considerable latency in communication. This will probably cause increasing scaling and capacity problems in the application servers if current client server technology is used. The use of synchronized communication between loosely coupled components that are physically and globally distributed does not function very well.

Different services may therefore require different implementation techniques. Client server technology works well for implementation of many Internet services today, but client server technology fails when it is used for implementation of services that are characterized by decentralization, loose coupling, and conflicting initiatives.

Network based services should be implemented with asynchronous messaging and with state machines that behave concurrently and communicate asynchronously. Currently J2EE based application servers support the client server paradigm for service development. This paradigm is not sufficient for implementation of network services.

Persistency of data is an important aspect of commercial services. State machines should therefore provide persistency of the data to be able to continue execution after system crash.

As described above there is generally a problem with well functioning links/compilers between high level model descriptions and source codes. This is also a serious problem within the ever-growing Java community, thus two of the main problems addressed by the present invention are:
1. How can concurrency between state machines and asynchronous messaging between state machines that are implemented on a J2EE platform be achievd?
2. How can an implementation of state machines take advantage of the support of persistency in the J2EE platform?

The present invention will provide methods that solve the problems indicated above.

### SUMMARY OF THE INVENTION

It is an object of the present invention to provide a method and an arrangement avoiding the above described problems.

The features defined in the independent claims enclosed characterize this method and arrangement.

In particular, the present invention provides a method for mapping of high level platform independent models to a source code and/or byte code platform, using the platform independent model comprising one or more state machines, and a generic middleware platform for orthogonally mapping the platform independent model to a source code and/or byte code platform where both platforms exhibit an asynchronous behaviour, and the mapping is achieved using message oriented middleware application API adapted for message exchange between clients in point to point messaging regime and, persistency for one or more state machines is achieved using one or more modules adapted for database transactions.

Further, the present invention discloses a generic middleware platform for orthogonally mapping an independent high level platform model to a source code and/or byte code platform, where both platforms exhibit an asynchronous behaviour, the platform independent model comprises one or more state machines, and the mapping is achieved using message oriented middleware application API, adapted for message exchange between clients in point to point messaging regime and, persistency for one or more state machines is achieved using one or more modules adapted for database transactions.

### BRIEF DESCRIPTION OF THE DRAWINGS

In order to make the invention more readily understandable, the discussion that follows will refer to the accompanying drawings.

FIG. 1 shows next generation network,

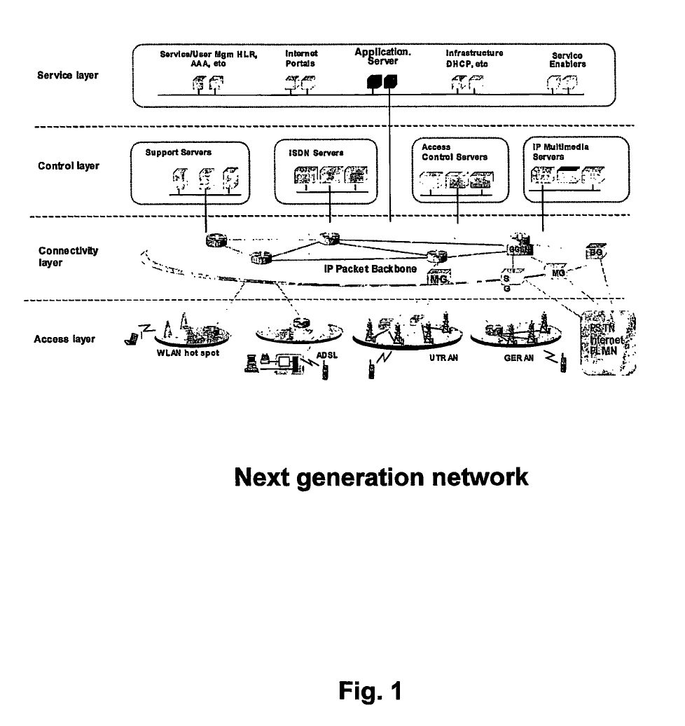

FIG. 2 shows a state machine of same type into one bean,

FIG. 3 shows that state machines of same type share one queue,

FIG. 4 shows implementation of state machines,

FIG. 5 shows EJBActorFrame, a framework for state machines on an application platform for Enterprise Java Beans

FIG. 6 shows operation of an actor state machine,

FIG. 7 shows EJBActorFrame classes,

FIG. 8 shows State data classes,

FIG. 9 shows domain model of the CATN service,

FIG. 10 shows CATN service scenario,

FIG. 11 shows Context Aware Services,

FIG. 12 shows CAS—interaction with environments,

FIG. 13 shows Class User,

FIG. 14 shows sequence diagram of CAS application,

FIG. 15 shows TrafficNews extends class Service,

FIG. 16 shows behaviour of class TrafficNews,

FIG. 17 shows implementation of the UML (Unified Modelling Language) class TrafficNews,

FIG. 18 shows mapping of Actor class to EJBActorFrame classes,

FIG. 19 shows Implementation of behaviour—class TrafficNewsCS,

FIG. 20 shows initialization of JMS and JNDI.

### DETAILED DESCRIPTION OF THE INVENTION

In the following the present invention will be discussed in a detailed description followed with a preferred embodiment, and by referring to the accompanying drawings. However, people skilled in the art will realize other applications and modifications within the scope of the invention as defined in the enclosed independent claims.

The present invention discloses a method for mapping models with a high level of abstraction to usable applications, or models with a low level of abstraction. The middleware according to the present invention renders an orthogonal connection between models of different level of abstraction. In an exemplified embodiment of the present invention the method disclosed is mapping a model with a high level of abstraction to a J2EE platform.

The above implies that a middleware layer is needed, where persistence exists, this is not given, as an example session beans will lose “everything” after execution of an action when in stateless. In the solution according to the present invention, message beans are used, and message beans are mainly equal to stateless session beans, hence persistency is needed and this can be achieved by the use of entity beans.

Further, it is quite a challenge when mapping, that there is a consistency between middleware level and higher and lower levels, that is; a part in the higher level has to be consistent with one in the middleware. Hence interfaces etc. has to fit, an asynchronic part cannot be replaced by a synchronic, or vice versa, a non persistent (e.g. session beans) cannot replace a persistent model on a higher level of abstraction.

Non blocking concepts can be achieved using a signalling model, where messages are asynchronously transmitted, that is; a protocol among other address information is needed, and the receiving party has to “open” the “mail” at a particular time. Persistency can be achieved if one has a unit storing data permanently. This can be handled by, for example, entity beans, whereas asynchronous communication can be handled by e.g. message beans through, for example JMS (Java Messaging Service). This implies having a JMS queue, and one or more message beans, where said message beans according to the invention will be state machines (SM) (as defined by the invention, and not necessarily according to traditional definitions), further one has a composite state machine (CS) which is a state machine in accordance with traditional principles, both CS and SM is managed by message beans, whereas data is fetched and stored etc. using entity beans, name convention can be handled by for instance JNDI.

Telecom companies have used SDL (specification and description language) in design of telecom products. Defined by the ITU-T (recommendation Z100) to provide a tool for unambiguous specification and description of the behaviour of telecommunications systems. The area of application also includes process control and real-time applications. SDL provides a Graphic Representation and a textual Phrase Representation which are equivalent representations of the same semantics. A system is specified as a set of interconnected abstract machines which are extensions of the Finite State Machine (FSM). Thus it has been possible to make a functional model of the system, which could be used for formal analysis, verification and validation, and for automatic generation of code. This model-oriented approach has proven to be successful in development of complex real time systems, like telecom systems. UML (Unified Modelling Language, a high level modelling language) has until now lacked the concepts and formalism that have made SDL successful in the telecom industry. UML has come from a background of enterprise applications where database modelling has been important, but with little demand and support for formal behaviour modelling. Today UML has become the de facto standard modelling language used in the software community.

With an active push and participation from leading telecom companies, the next version of UML has taken a long step in the direction of SDL. The proposal for UML2.0 [1] has the language concepts and formalism needed to support a model driven approach to development of telecom systems.

OMG (Object Management Group) has recently changed the focus to UML as the core language to be used in a modelling approach, called Model Driven Architecture (MDA). MDA defines two different UML models.

PIM is a platform independent UML model, which can be reused in different implementations.

PSM is a platform specific model that is tailored to an actual middleware platform.

The idea is to first make a PIM model and then transform it to a PSM model. A PSM model can then be automatically or manually transformed to an implementation using a specific platform like J2EE or .NET [3].

The service network including Internet may consist of active components, meaning that the components can act on their own. For instance, multiple sensors can cause events to be sent simultaneously, causing conflicting requests to the services. This will cause concurrency problems if the services are implemented with technologies that are based on synchronized communication between the active components. Higher latency will increase the “window” for concurrency conflicts. Slow and non functioning services may be the result. It is therefore important that application platforms can handle conflicting initiatives to the same applications from many sources simultaneously.

These problems have been addressed by research projects. Khare [4] argues for use of asynchronous messages (events) for communication between what he calls network services. Network services are characteristically decentralized, which means that they are crossing organizational boundaries. Network services are also loosely coupled, and are typically implemented with different technologies.

Different services may therefore require different implementation techniques. Client server technology works well for implementation of many Internet services today, but client server technology fails when it is used for implementation of services that are characterized by decentralization, loose coupling and conflicting initiatives.

One objective for the present invention is to investigate how the UML2.0 concepts, that ActorFrame, a framework for state machines, are based upon, can be implemented and deployed by using middleware platforms that support J2EE technologies

ActorFrame is a generic application framework that supports the concept of actors and roles [1]. With ActorFrame actors play roles and involve other actors to play other roles using a role request protocol. Actors may contain other actors. Ericsson has developed a prototype of a Java framework called ActorFrame, for development and execution of services. The services will be deployed in networks where current Telecommunication and Internet has merged into an open service oriented network. The services are modelled using UML 2.0 concepts for concurrent state machines communicating asynchronously through message passing. ActorFrame has been used in development of prototype services deployed in real networks as part of the AVANTEL research project. The background for the present invention was that Ericsson wants to move ActorFrame to a J2EE technology.

Principle Implementing of State Machines on J2EE

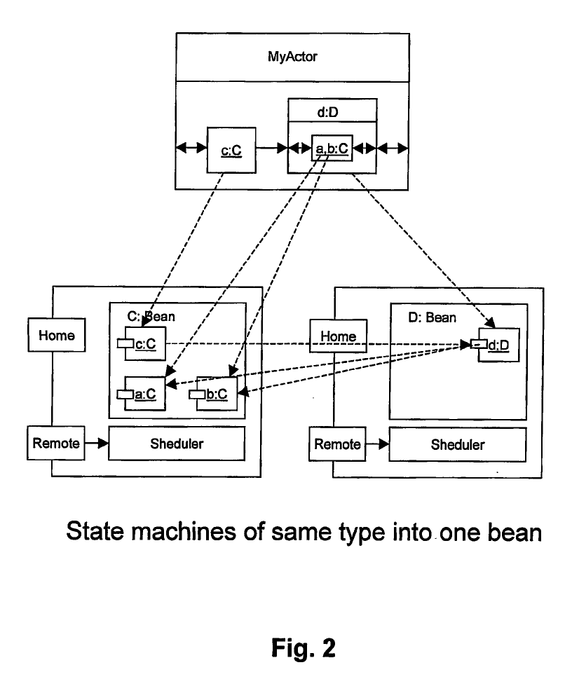

There are many possible ways of mapping ActorFrame to the J2EE platform. Each alternative has different characteristics regarding performance, resource usage, persistence etc. Normally a system consists of a smaller number of different types of state machines. The number of instances of each type of state machine may vary a lot from a single one to thousands. As illustrated in FIG. 2 all instances of a state machine type will be implemented by one bean.

Implementation of a state machine in this solution requires:
A message bean that receives message asynchronously and contains the behaviour of the state machine.
An entity bean that stores the state data for each state machine instance persistently.

A message bean is designed for receiving messages from JMS. It does not provide persistence of data and it is normally short-lived. The JMS Destination controls the execution of the bean. When a message arrives at the JMS Destination specified at deployment time, the container activates a random message bean from a pool of message beans.

A message bean implements the state machine, but it cannot store data for that particular instance if data are to survive a system crash. It has to use another storage medium for that, or it may use CMP (Container Managed Persistency) entity beans which also provide persistence and transaction control. The behaviour structure of the state machine, which is common for all instances of the same state machine type, can be stored in the message bean.

The container provides multiple instances of message beans in a pool created at deployment time. Hence, more than one message bean may receive messages for the same state machine. This must be prohibited because the same state machine cannot execute simultaneously.

A message bean is very simple to implement. It has no remote or home interfaces. This solution will scale well. Only few message beans are necessary for a specific state machine type. The state data for each state machine will be “loaded” and “stored” for each transition.

Asynchronous Communication

Asynchronous communication between the state machines is essential. The first versions of J2EE did not provide asynchronous message passing. Version 2.0 integrated JMS with EJB to achieve this. The message bean is integrated with JMS, and this provides a good solution for asynchronous communication between state machines. The other types of beans can only send, and synchronously receive, JMS messages, which means that the bean can call a JMS destination and then wait for a message. This will block the bean to be called by other beans or clients.

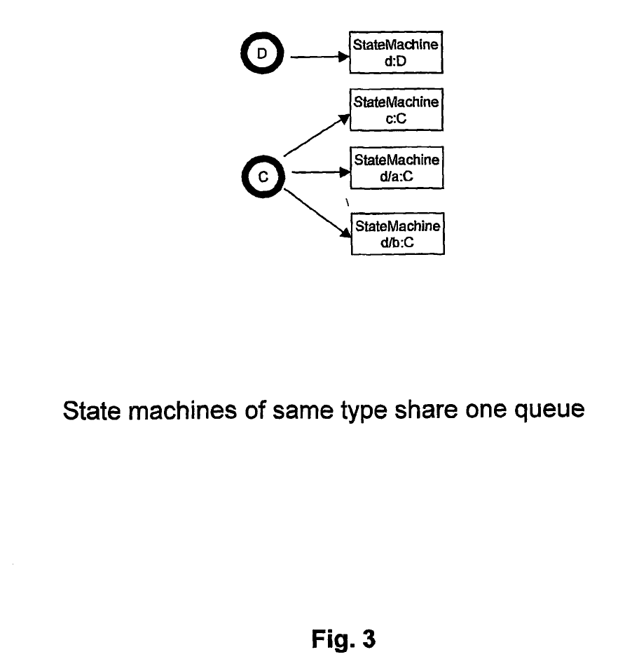

JMS provides different mechanism that can be used to make an infrastructure of state machines. In principle there are the following possibilities:
1. All state machines share the same queue.
2. One queue for each state machine
3. One JMS queue for each type of state machine (FIG. 3)

The solution selected according to the present invention is to group all state machines of the same type into one bean and let this bean wait for message from only one queue. This solution will reduce the number of queues and increase the performance. The receiving bean needs only to “load” and “store” the state data for the state machine that is addressed in the message.

Framework for Implementation of State Machines on J2EE

The framework supports the Actor concept that in addition to be a state machine, supports a role request protocol. The actor is part of the ActorFrame that Ericsson has developed.

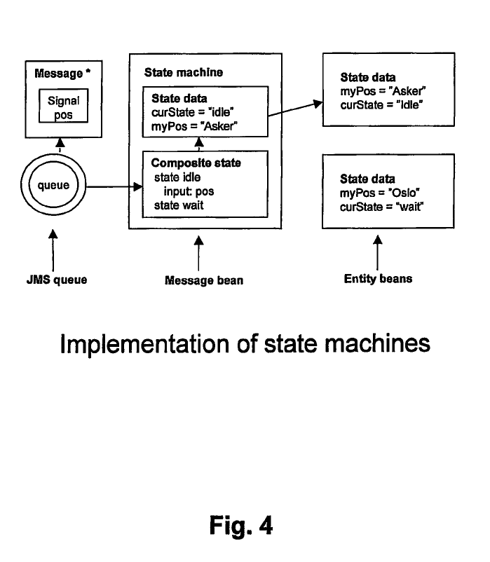

The principle solution for implementing the state machines on an EJB middleware platform is shown in FIG. 4. The state machine is implemented as part of a message driven bean that receives signals from a single JMS queue. The state data is stored as entity beans. The state data is copied to the state machine to obtain a backward compatibility of previous implemented state machines. The reasons for selecting this mapping solution are:
Use of entity beans to achieve persistency and transactional support of state data.
Use of message beans to get a seamless integration with JMS, to achieve asynchronous communication and to limit the amount of queues.
Use of entity beans, which are optimized for large amounts of data, to achieve scalability and persistent storage of state data.
To use EJB/J2EE as it was intended.

The main drawback caused by splitting the state data from the state machine behaviour is partly reduced by using local references between the message bean and the entity bean. Calls to state data are then done by reference avoiding the extra burden caused by invoking RMI.

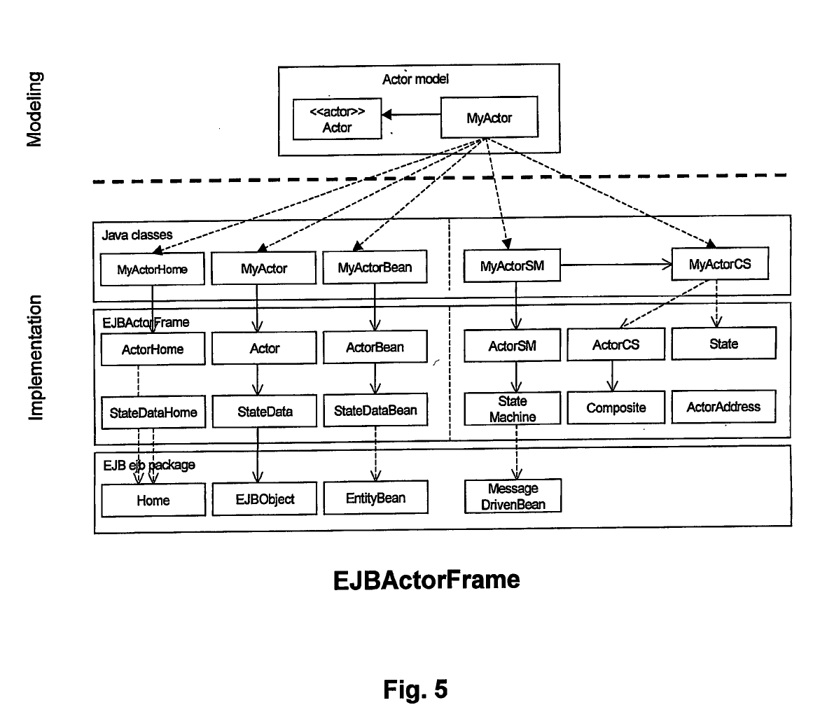

The implementation is split into three layers as shown in FIG. 5 EJBA Actor Frame.
Java code that implements the application specific functions. It uses ActorFrame classes from the EJBActorFrame package, a package with a framework for state machines on an application platform for Enterprise Java Beans.
EJBActorFrame is the actual implementation of the ActorFrame concepts according to the present invention that the model uses.
The EJB package provides classes for implementation of EJB applications.

It is the implementation of the classes in the EJBActorFrame package that is specific for the EJB platform. These classes have the same signature as the classes in the ActorFrame package, which ensure the portability of the implementation to other middleware platforms.

The following subchapters will describe the different parts (classes) of EJBActorFrame.

Principle behaviour of EJBActorFrame

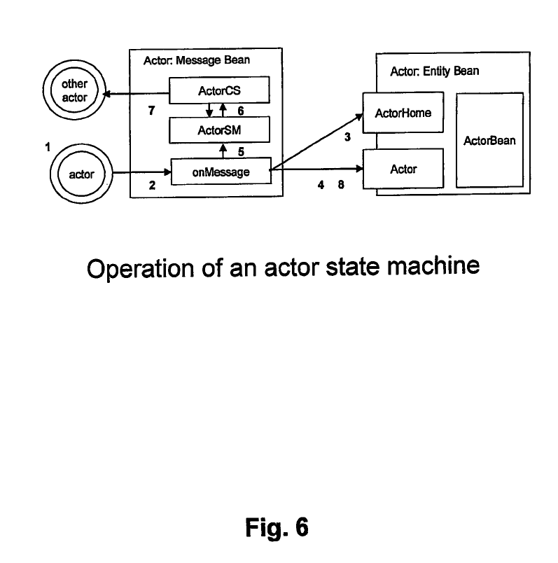

In FIG. 6 the conceptual solution of the implemented state machine is shown. An asynchronous message passing is obtained by using a JMS queue for reception of signals to the state machine. A message driven bean contains the behaviour of the state machine and the state data is stored in entity beans.

Input signals trigger transition in the state machine. This is obtained through following the steps numbered according to the figure above.
1. A JMS message is sent to the queue named “actor”.
2. JMS calls the on Message method in the message bean with the message as parameter. The onMessage method checks if the message contains an actor message (type ActorMsg). If not, the message is skipped.
3. The reference to the entity bean's home object was obtained through lookup in JNDI name server when the message bean was created. This reference is now used to call the findByPrimary( ) method, which finds the entity bean that contains the state data of this actor instance. The instance identification is obtained through the receiver address of the received message. The findByPrimary( ) method returns a reference to the actor object of the entity bean.
4. The on Method( ) calls the method getCurrentState( ) in the Actor interface of the entity bean, which returns a string currentStateId representing the current state. Eventually a transaction will be started.
5. The actual state object is found by searching through the state hierarchy to find the state that is equal to the currentStateId. A reference to this state is stored in the currentState variable.
6. The execTrans( ) method of the current state object is called with an instance of ActorMsg as a parameter. ExecTrans( ) checks if the current state contains this signal. If so, a transition is triggered.
7. New signals may be sent during the transition to other JMS destinations representing the input queues for other actors.
8. If the destination of the transition is a new state, the currentstateId is updated. The state data is stored in the entity bean by calling the setCurrentState( ) method of the entity bean. The transaction is eventually ended.

The steps above are similar for all sub types of class Actor. If sub types of class Actor are defined, the state date for the subtypes may be extended with new attributes. If so, the instances of these attributes have to be retrieved from the entity bean defined for that subtype. This will be explained in the section describing a first preferred embodiment of the present invention, where an example of implementation of subtype of an actor is shown.

Description of EJBActorFrame

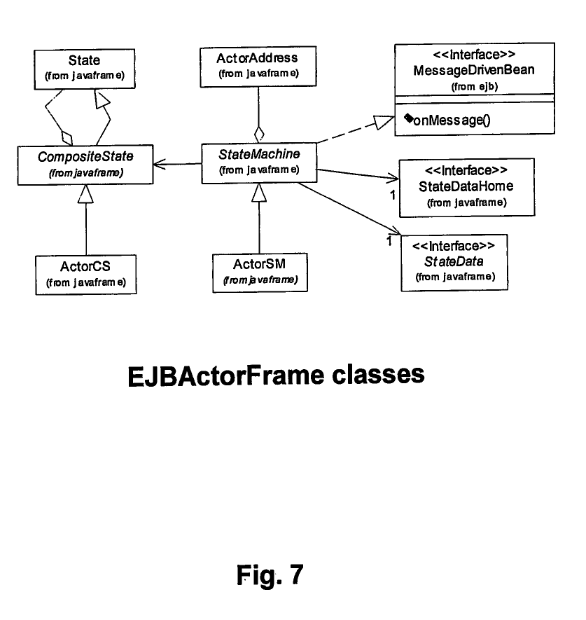

EJBActorFrame consists of two parts of classes, behaviour and state data related classes. In FIG. 7 the classes for implementation of the behaviour of the state machine are shown. This class implements the interface MessageDrivenBean from the EJB package. As described in the introductory part under the section message beans, the MessageDrivenBean interface contains only the on Message method, which receives messages from specified JMS queues. Class StateMachine has references to the interfaces of the entity bean where the state data of the state machine is stored.

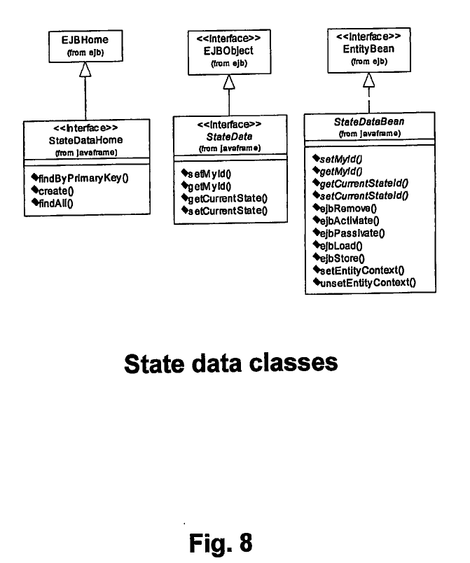

In FIG. 8 the classes for implementation of state data as an entity bean are shown. The class StateDataBean is the implementation class of the entity bean. It contains the definitions of each data element of state data. State data contains a string currentState that represents the current state of the state machine and an actor identity myId, which is also the primary field for the entity bean.

The properties of an entity bean are specified by defining abstract “get” and “set” methods for each of the properties. These are listed in the operation field of the class StateDataBean marked with cursive script. The other methods in class StateDataBean are the standard methods that an entity bean has to implement according to the EJB standard. These methods are empty, but they may be overridden in subclasses of the class StateDataBean. Each of the get and set methods are also specified in the interface called StateData. These methods define the business methods that are available for other beans, which in this case is the class StateMachine.

The interface StateDataHome defines the methods used to find or create entity beans. The method findByPrimaryKey( ) finds the state data for a specific state machine instance. The primary key myId represents a unique identification of a state machine instance.

The class StateMachine is the only client that accesses the StateData entity bean. To optimize access to state data the local home and local remote interfaces are used¹. A method call to the state data bean is then done by reference and not RMI. A prerequisite is that both the entity bean and the message bean are deployed in the same jar file.
¹ Because the application server JBOSS seems to not support use of local interfaces of beans, the ordinary remote interfaces were in the implementation of EJBActorFrame package. JBOSS supports optimization of calls between beans deployed in the same container.

The Implementation of State Machine as a Message Bean

The class StateMachine implements the message bean interface. This interface contains one method on Message that is called by the container when the message bean receives a JMS message.

StateMachine is an abstract class. It contains abstract methods that must be defined in the concrete subclasses of class StateMachine. These methods are listed in table 1. Common for all these abstract methods are that they are specific for the EJB bean that implements the subtype of class StateMachine. These methods are called from the class StateMachine. In the definition of the class StateMachine the goal has been to simplify what has to be implemented in the subtypes. In general the class StateMachine contains functionality needed to execute a general state machine including persistency of state data. An example is given in the section describing the first preferred embodiment of the present invention to illustrate this.

Class Actor is a subtype of class StateMachine and it defines all the abstract methods listed in the table below. A new class that is a subtype of class Actor does therefore not define these methods, unless properties are added in the subtype.

TABLE 1
Abstract methods in class StateMachine

| Abstract method | Description |
|---|---|
| getData | Reads the state data that is specific for the subtype into |
| | the corresponding attributes of the subtype |
| storeData | Stores the attributes of the subtyped state machine that |
| | is specific to the subtype. |
| createInstance | Creates a new instance of the state machine, which |
| | means a new bean |
| findEntityBean | Finds an entity bean with the specified instance name |
| | and returns a reference to the local object |
| findAllInstances | Finds all instances of a state machine type and returns |
| | a collection of references to the local objects |

The behaviour of the state machine is defined by extending the class CompositeState. The implementation follows the pattern defined for JavaFrame.

Use of JMS

JMS is used for achieving asynchronous communication between actors. The queue mechanism in JMS is designed for architectures where multiple clients send messages to a single recipient. This is in line with actor concept where actors are sending signals between each other.

The solution showed in FIG. 3 uses a single queue as input to all instances of the same actor type. A typical system will then consist of only a few queues. Addressing an actor is the same as sending a signal to the queue attached to the message bean that implements the actor type.

JMS queues and JMS topics are called managed objects in the J2EE standard. Managed objects are created and deleted independently of the deployed beans. The middleware vendors may do this differently. In the application server JBOSS a separate xml file defines the JMS queues that are deployed in an application server. The queue names are stored in JNDI and the beans can use JNDI to find references to the names.

In EJBActorFrame the message type Object is used to convey actor messages. The class ActorMsg is serialized by JMS before it is delivered to the destination. Automatic acknowledge is used to guarantee that a message is delivered to the message consumer, which in this case is a message bean.

Other clients, like Servlets and other java applications, can access JMS queues. This makes it easy to integrate loosely coupled components distributed on the net. Clients implemented in other languages can also communicate via JMS.

Concurrency and Asynchronous Communication

Concurrency in this context does not mean that the state machines have to execute in parallel. Concurrency between state machines is a conceptual way of organizing the software. Each state machine can be run independently and if desirable, be executed in parallel. Asynchronous communication is tightly coupled to independent execution of state machines. Synchronous calls between state machines will cause dependencies between them.

The solution according to the present invention is a trade-off between performance and resource usage. All instances of one state machine type are implemented by one message bean that receives signals to these instances from one JMS queue. Asynchronous communication between state machines is achieved using this solution. All signals are sent through JMS queues, which results in state machines that are decoupled from each other both in time and space.

The solution described does not allow distribution of instances of the same state machine. All instances have to be executed in the same container.

There is also a possibility to use the selection mechanism in JMS to choose between signals. One message bean could receive signals for a sub set of the state machine instances.

Another solution is to use bean managed transaction control. The entity bean that keeps the state data for an instance can be locked during the transition, which will prevent “dirty” reads from other message beans.

In cases where JMS may cause significant performance reduction due to an increasing number of signals sent between state machines in these situations could tightly coupled state machines, be implemented in the same message bean, and “lightweight” queues could be used instead of JMS queues for signalling between the state machines.

In the sections above it has been shown that according to the present invention the first of the two main objectives addressed in the introductory part have been solved;
Concurrency between state machines can be achieved using entity beans combined with the quasi-parallel execution of beans supported by an EJB container.
Asynchronous communication between state machines is achieved by using JMS queues combined with message beans.
   Persistent State Machines

The specification of EJB/J2EE requires that an EJB container shall support persistency of entity beans. This is called Container Managed Persistency (CMP).

However, using this solution will decrease the performance of an application. For every signal the state machine receives, the state data are first read, the transition executed, and then the state data are written back to the entity bean. This solution ensures backward compatibility with previously implemented applications based on ActorFrame. Another solution could be to pass the entity bean reference to the transition, and then use get and set methods to access the state data during the transition. This solution will considerably reduce the overhead of using the entity bean for storing state data.

The proposed solution implements all actors as persistent state machines. This is probably not necessary. A property of the actor stereotype could be used to define if an actor should provide persistent state data. If no persistency is needed, the state data could be stored as local data in the message bean.

Naming is a critical issue when it comes to addressing state machines, UML objects may have references to other objects. Sending a message to a state machine is done by using the reference to the other object.

An ejb bean can be globally referenced. JNDI is used to store global names for the beans. These names can be set at deployment time, so one solution is to map names of ports to JNDI names that refer to a JMS destination. State machines will then be associated with the JNDI name of the JMS destination.

In this section it has been shown that according to the present invention the last of the two main objectives addressed in the introductory part has been solved, in that the implemented solution that used container managed persistency types of entity beans for storage of state data, is a solution to the problem of how to achieve persistent state machines on the J2EE platform.

### A First Preferred Embodiment of the Invention

Implementation of a Service Using EJBActorFrame

An example of how to map an application modelled with ActorFrame concepts to the J2EE platform is presented in this section. The example is described using the EJBFrame profile package for UML2.0. The application is implemented using the EJBActorFrame Java package described in the section Principle implementing of state machines on J2EE.

The figures in this chapter are neither complete, nor do they have correct UML syntax. The arrows in associations are always closed, although in most cases these should be open. It neither contains a complete description of the design, nor the implementation. The presentation is meant to ease the understanding of how the different parts of an ActorFrame model are implemented. State machines are almost coded according to the pattern proposed in JavaFrame.

Traffic News—a Context Aware Service

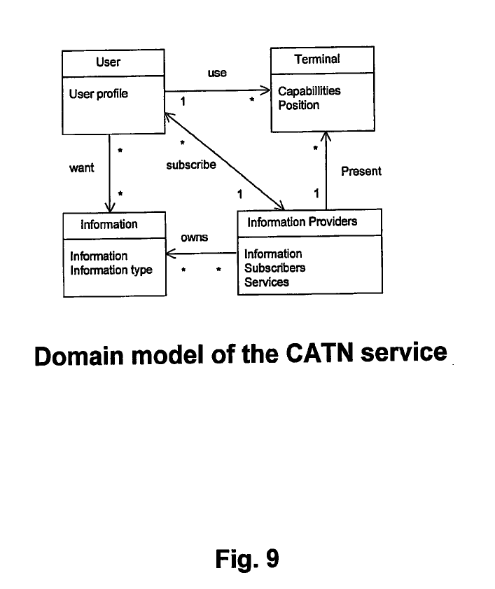

Context Aware Traffic News (CATN) is a service that restricts the flow of traffic news to only news that is relevant to the user. The selection criterion is based on the current position of the user. A typical situation is a user who is travelling by car which is approaching a traffic jam. The user, who subscribes to this CATN service, receives a sms message on his mobile phone, telling the user about the traffic jam 5 km ahead. The user can then drive an alternative route to his destination. The user does not receive traffic news that is not relevant to him. A UML domain model of this service is shown in FIG. 9. A domain model describes the most import concepts in the domain of interest. The model describes that User wants Information, which in this case is relevant traffic news. The User has Terminals, where the user receives relevant information. The terminal has a Position. An Information provider receives information from different sources, and the Information provider selects the subscribed information and presents it to the User on his Terminal dependent on the current position of the terminal. This domain model does not state anything about how this service is implemented.

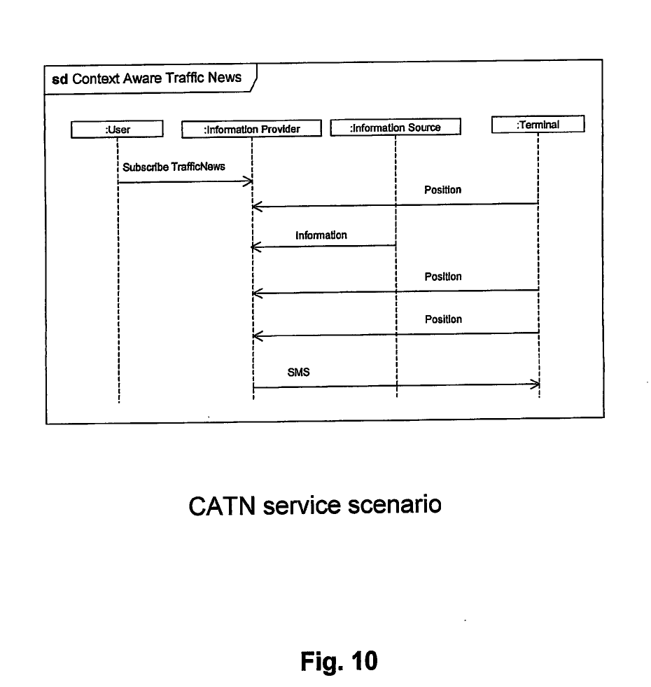

A typical scenario is shown in FIG. 10, where the Information Provider sends only relevant information to the User, when the position of the terminal indicates that this information is relevant to him.

Design of CAS

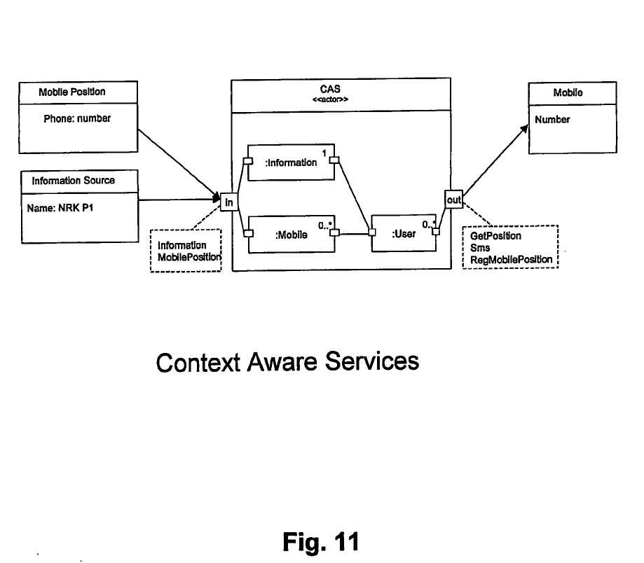

The service CATN introduced above is an example of a service that a Service provider would like to offer its customers. An application called Context Aware Services (CAS) is therefore proposed, where a different kind of context aware services may be implemented. A design model of the CAS application is shown in FIG. 11.

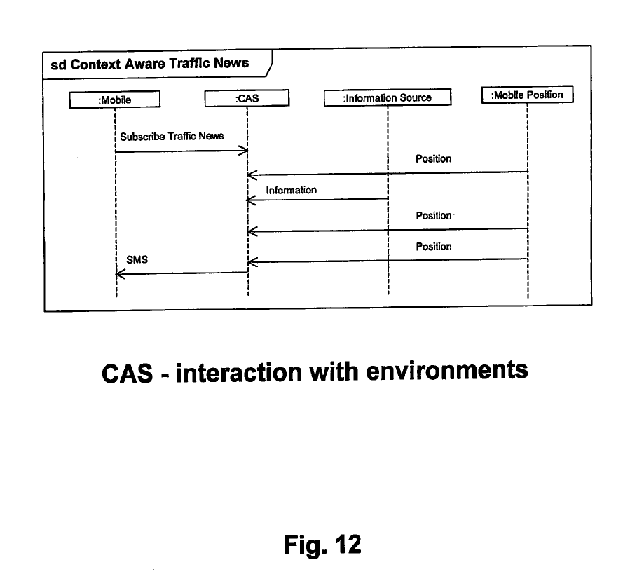

The CAS application communicates with a mobile positioning system, different information sources like e.g. Traffic News on the Radio (NRK P1), and with mobile phones through GSM systems. The different signals that the application receives and sends through its ports are shown in comments attached to the ports. The interaction diagram in FIG. 12 shows the scenario described in FIG. 10, where the application CAS is represented as one instance in the diagram.

The CAS application consists of one instance named TrafficNews (indicated by the number 1 in the upper right corner of the box) of class Information, zero or more instances (indicated by a 0 . . . ) of classes Mobile and User.

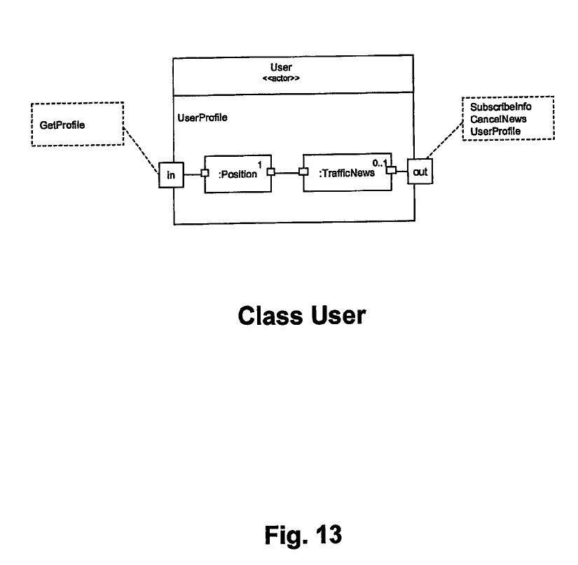

The class User is shown in FIG. 13 and consists of one Position instance and zero or one instance of class TrafficNews. All these classes are stereotyped with actor, like the class User shown in the figure below.

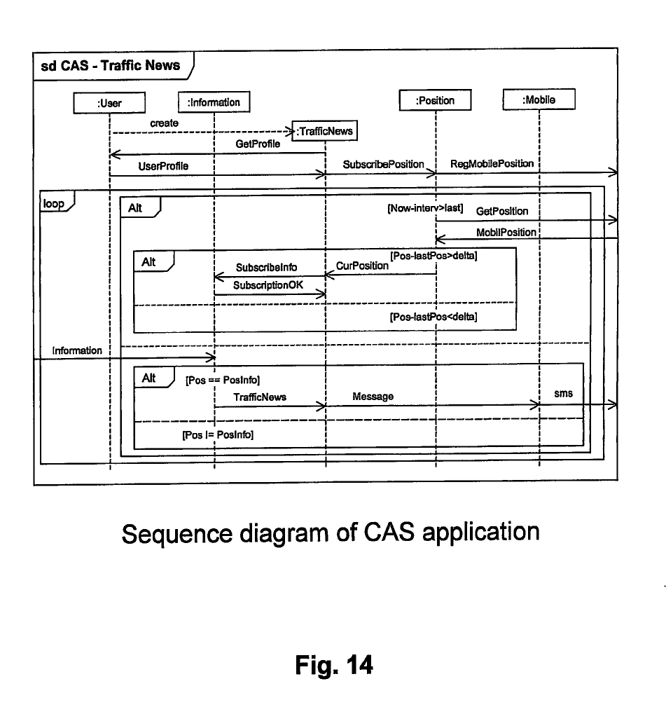

The sequence diagram for the TrafficNews service is shown in FIG. 14. This diagram uses UML2.0 notation for sequence diagrams. The diagram describes two sets of alternatives, and a loop.
Loops: describe a loop of sequences that are repeated until a condition is satisfied.
Alternatives: describe a set of possible sequences of interactions separated with a dotted line.

An interesting note to this diagram is that TrafficNews and Position is part of User (see FIG. 13) and these instances could therefore be modelled in one lifeline, which WOULD have simplified the diagram. A new sequence diagram for User would have shown the internal interaction of User.

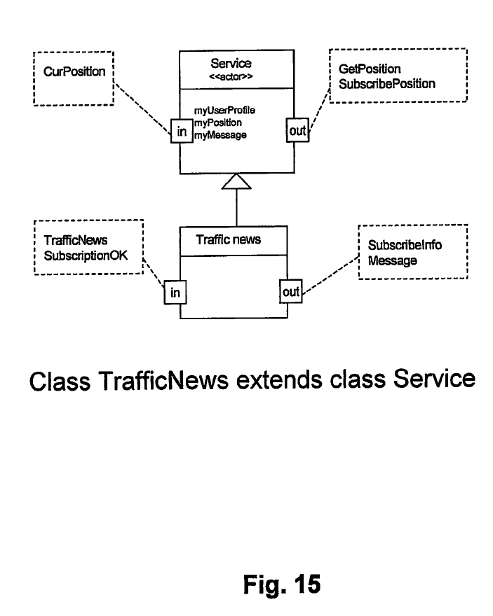

The class TrafficNews is shown in FIG. 15. It inherits the class Service, which is common for all CAS services. The class Service specifies common properties and behaviour such as UserProfile and the communication with the User to obtain the user profile. The class TrafficNews adds the service specific attributes and behaviour including signals.

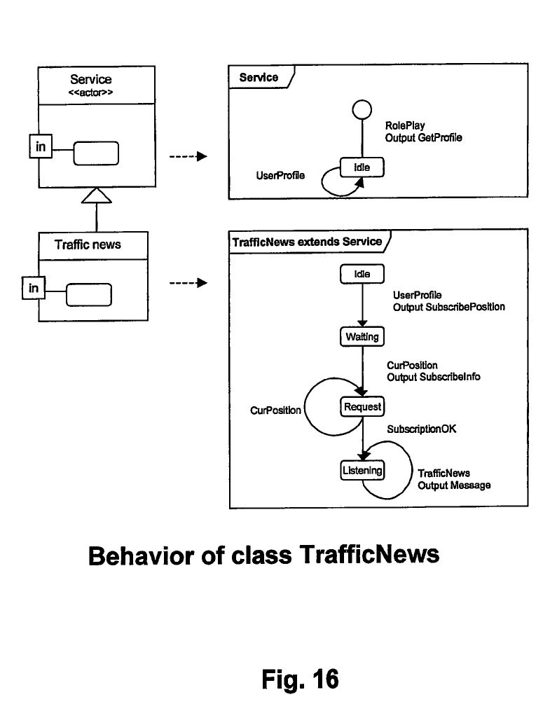

The behaviour of class TrafficNews is modelled as a state machine as shown in FIG. 16. The state machine of TrafficNews extends the behaviour of the state machine of the super class. The transition caused by reception of the event UserProfile in state Idle is redefined in the state diagram for class TrafficNews. An output signal SubscribePosition is sent and the next state is set to Waiting.

Implementation of CAS

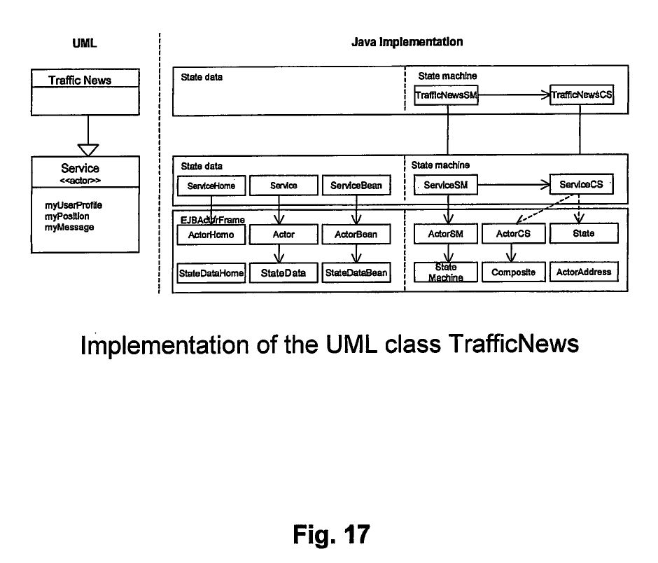

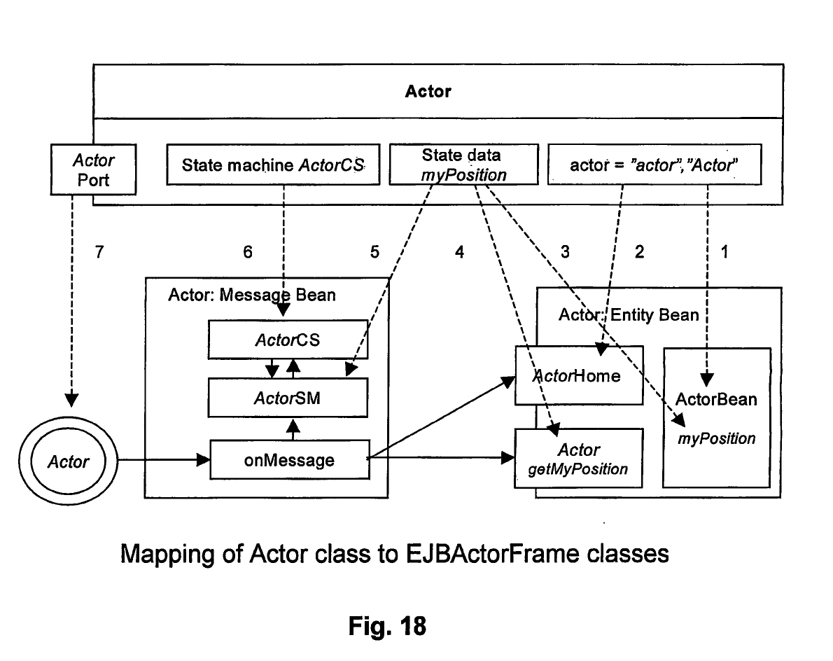

The CAS application is implemented by extending the classes defined in the EJBActorFrame Java package. In the FIG. 17 the classes that must be implemented for each actor are marked in grey. The FIG. 18 describes how different parts of actors are mapped to these classes. The UML class TrafficNews and its super class Service are used as an example of how each Java class is implemented.

The UML class TrafficNews inherits the class Service. The class TrafficNews does not add new properties or state data. It is only the state machine that is extended. Therefore the classes that implement the state data as entity beans are omitted as illustrated in FIG. 17.

Implementing of Behaviour of State Machines

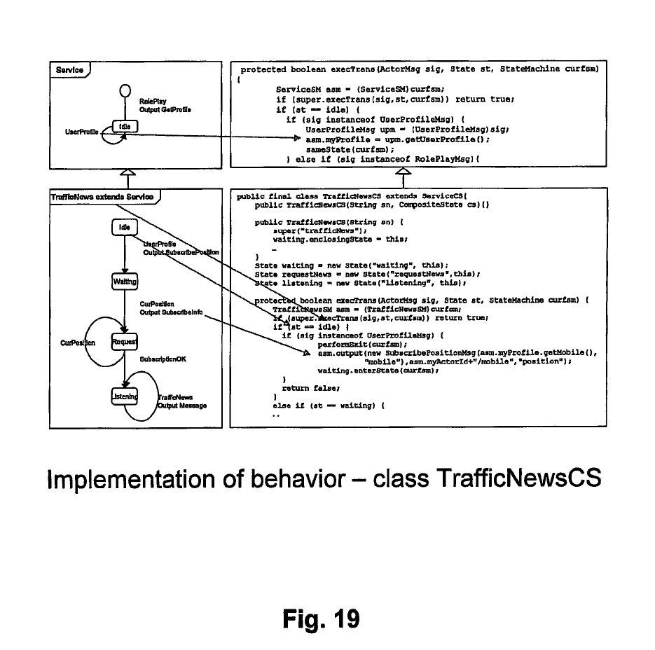

The behaviour of the UML class TrafficNews is implemented in the class TrafficNewCS. It extends the class ServiceCS as illustrated in FIG. 19. The figure describes how the different parts of the state chart of class TrafficNews are implemented. The method execTrans is called when this state machine receives a signal. The second statement in this method shows how the state machine of its super type Service is called. According to the UML2.0 a transition may be redefined, but it cannot be extended. That means that if the subclass accepts the signal, the super type class shall not be called. The JavaFrame pattern does the opposite by calling the super type first. If the super type accepts the signal, the sub type discards the signal. In this example the super type is called first, and if the sub type has defined the same signal, the transition in the subtype is also executed. The semantic is that the subtype may also extend the transition and it allows new target state to be defined. This solution ensures that the behaviour defined in the super type will be executed, but it allows adding behaviour in the sub type. In this case an output of the signal SubscribePosition is added and next state is redefined to state waiting.

FIG. 19 shows also how state data is accessed in a transition. Transition for class Service for the signal UserProfile defines an assignment of asm.myProfile to the profile carried as data in the received message. Asm is a reference to current state machine, which contains the state data. This is according to the JavaFrame pattern. The variable myProfile was read from the entity bean before the ExecTrans was called and it is stored again after the transition.

Use of JMS and JNDI

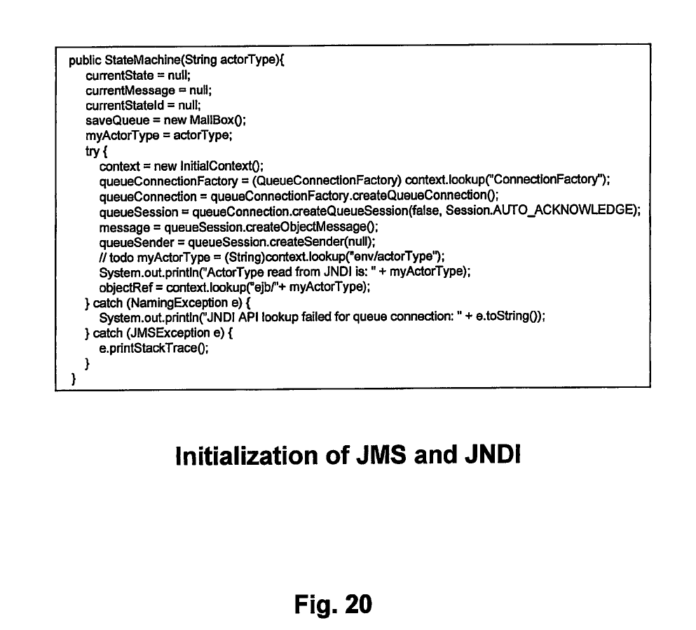

JNDI is used for finding JMS queues, entity beans and for reading input variables defined in the deployment descriptors. Most of the code is implemented in the class StateMachine. The constructor of class StateMachine does most of the initialization as shown in FIG. 20. This constructor is called from the sub type with the name of the actor type as a parameter. This may be changed to allow the constructor to read from an environment variable that defines the actor type as the statement commented as “todo” in the code. The name of entity beans, JMS queues and environment variables are defined in the deployment file and the container reads these names and stores them into JNDI.

Conclusions regarding the present invention are that J2EE has technologies that support asynchronous communication, and it is possible to combine this communication style with implementation of persistent state machines.

Use of state machines gives the following advantages:
Asynchronous communication between state machines decouples the J2EE applications from the other applications that are called, or call this application
Parallel or quasi parallel execution of the state machines that ensures handling of conflictive initiatives from the different active components that J2EE servers must handle.
The data of the state machine are persistent, which makes the application robust against system crash.
Increased scalability of applications because state machines will be easier to distribute.
The implementation of applications is trivial, which ensures an increased quality.

Note that while in the foregoing, where a detailed description of particular embodiments of the present invention has been provided, it is to be understood that equivalents are to be included within the scope of the invention as claimed.

Abbreviations

3GPP—3 Generation Partner Program
AAA—Authentication, Authorization, and Accounting
ALIN—Application Layer Internet working
API—Application Programming Interface
ACID—Atomicity, Consistency, Isolation and Durability
BMP—Bean Managed Persistency
CMP—Container Managed Persistency
CORBA—Common Object Request Broker Architecture
CS—Composite State
DNS—Domain Name Server
EJB—Enterprise Java Beans
   FTP—File Transfer Protocol
GSM—Global System for Mobile communication
HLR—Hosting Location Register
HTP—Hyper Text Protocol
ICT—Information and communication Technology
IIOP—Internet Inter-Orb Protocol
JAX-RPC—Java XML based Remote Procedure Call
J2EE—Java 2 Enterprise Edition
J2SE—Java 2 Standard Edition
JDBC—Java Data Base Connectivity
JMS—Java Messaging Service
JNDI—Java Naming Directory Interface
JVM—Java Virtual Machine
MDA—Modelling Driven Approach
MDA—Model Driven Architecture
MDK—Modelling Development Kit
MOM—Message Oriented Middleware
MSC—Message Sequence Chart
OSA—Open Service Access
PIM—Platform Independent Models—used in MDA terminology
PSM—Platform Specific Models—used in MDA terminology
RMI—Remote Method Invocation
RMI/IIOP—Remote Method Invocation over Internet Inter-Orb Protocol
RPC—Remote Procedure Call
SCS—Service Capability Server
SDL—Specification and Description Language
SMTP—Simple Mail Transfer Protocol
SOA—Service-Oriented Architecture
SOAP—Simple Object Access Protocol
SM—State Machine
UDDI—Universal Description, Discovery, and Integration
UML—Unified Modelling Language
UMTS—Universal Mobile Telecommunications System
WAP—Wireless Application Protocol
WSDL—Web Services Description Language
XML—Extensible Markup Language
UMTS—Universal Mobile Telecommunications System

### REFERENCES

1. Using J2EE Technologies for Implementation of ActorFrame Based UML2.0 Models; Melby, Geir; Master Thesis in Information and Communication Technology; Agder University College Grimstad, Norway; May 2003.
2. J2EE—Java 2 Enterprise Edition; Sun; http://java.sun.com/j2ee/
3. NET; http://www.microsoft.com/net/
4. Rohit Khare; Soap routing; the missing link; O'Railly Emerging Technologies Conference; UC Irvine & Know How, Inc

1. A method for mapping of high level platform independent models to a source code and/or byte code platform, using a high level platform independent model comprising one or more state machines, and a generic middleware platform for orthogonally mapping the high level platform independent model to the source code and/or byte code platform where the high level platform independent model and the source code and/or the byte code platforms supports asynchronous behaviour, and the mapping is characterized in the steps of:
a) use a message oriented middleware application API for message exchange between clients in point to point messaging regime, and
b) apply one or more modules supporting database transactions hence achieving persistency for one or more state machines.

2. The method according to claim 1, characterized in that step b further comprises the step of, concurrently accessing the one or more modules from the clients.

3. The method according to claim 1, characterised in that the method further comprises the steps of:
implementing the platform independent model as a UML model sterotype such as ActorFrame,
implementing the source code and/or byte code platform as a J2EE platform,
implementing a combination of one or more message beans with one or more JMS queues as the message oriented middleware application API,
implementing the one or more modules supporting data base transactions with entity beans.

4. The method according to claim 1, characterized in mapping the one or more state machines from the UML platform to the J2EE platform and implementing the one or more state machines on the J2EE platform, comprises at least the steps of:
sending messages asynchronously to a message bean, where said messages contains the behaviour of said state machine, and
storing data for each state machine instance persistently using entity beans.

5. The method according to claim 3, characterized in that, mapping the one or more state machines from the UML platform to the J2EE platform and implementing the state machine(s) on the J2EE platform is achieved by the steps of:
using a message bean, and
using a CMP entity as a storage medium for the message bean.

6. The method according to claim 4, characterized in that
the one or more state machines implemented on the J2EE platform communicates asynchronously, and/or
let all state machines of the same type share the same JMS queue.

7. A generic middleware platform configured for orthogonally mapping an independent high level platform model to a source code and/or byte code platform, where the independent high level platform and the source code and/or byte code platform are adapted for an asynchronous behaviour, the platform independent model comprises one or more state machines, characterized in that the generic middleware platform further comprises:
a message oriented middleware application API adapted for message exchange between clients in point to point messaging regime, and
one or more modules adapted for a database transactions, thus achieving persistency for the one or more state machines.

8. The generic middleware platform according to claim 7, characterized in that the one or more modules are configured to handle concurrent access from multiple clients to the database.

9. The generic middleware platform according to claim 7, characterized in that:
the platform independent model is a UML model stereotype such as ActorFrame,
the source code or byte code platform is a J2EE platform,
the message oriented middleware application API adapted for message exchange between clients in point to point messaging regime is one or more JMS queues combined with one or more message beans, and
the modules adapted for database transactions are entity beans adapted for handling concurrent access from multiple clients to the database.

10. The generic middleware platform according to claim 9, characterized in that
the generic middleware platform is configured to map the one or more state machines from the UML model platform to the J2EE platform, and the generic middleware platform further comprises:
at least one message bean configured to receive messages asynchronously, where said messages contain the behaviour of said state machine, and
an entity bean that stores the data for each state machine instance persistently, or
the at least one message beans is adapted to use a CMP entity as a storage medium.

11. The generic middleware platform according to claim 10, characterized in that
the one or more state machines implemented on the J2EE platform is configured for asynchronous communication and,
all state machines of the same type are adapted to share a same JMS queue.

12.-14. (canceled)
